(19) United States
(12) Patent Application Publication
(10) Pub. No.: US 2017/0308076 A1
(43) Pub. Date: Oct. 26, 2017

(54) UAV AERIAL PHOTOGRAPHING SYSTEM

(71) Applicant: Yuneec International (China) Co., Ltd., Jiangsu Province (CN)

(72) Inventors: Yu TIAN, Jiangsu Province (CN); Wenyan JIANG, Jiangsu Province (CN)

(21) Appl. No.: 15/493,746

(22) Filed: Apr. 21, 2017

(30) Foreign Application Priority Data
Apr. 22, 2016 (CN) 201610257214.6

(51) Int. Cl. G05D 1/00; G08G 5/04; B64C 39/02; B64D 47/08; H04N 7/18; G06K 9/00

(52) U.S. Cl. CPC G05D 1/0016; H04N 7/185; G08G 5/045; G06K 9/0063; B64C 39/024; B64D 47/08; G05D 1/0094; B64C 2201/127; B64C 2201/146

(57) ABSTRACT

The present invention discloses a UAV aerial photographing system having a remote control device, a UAV, and a PTZ camera, wherein the remote control device is used to transmit a flight instruction to the UAV; wherein the UAV is used to fly in any one of the following modes according to the flight instruction: mode 1: flying around a first target point with a preset radial distance; mode 2: flying a first preset distance on a straight line formed by a target point and a lens angle of the PTZ camera in a direction away from the target point; mode 3: flying according to a curved preset path; mode 4: flying with a preset angle and a second preset distance kept between the UAV and the remote control device; and wherein the PTZ camera is used to perform photographing during flight of the UAV.

### CROSS-REFERENCE TO RELATED APPLICATION

This application claims priority to Chinese Patent Application No. 201610257214.6, filed Apr. 22, 2016, which is incorporated herein by reference it its entirety.

### FIELD OF THE INVENTION

The present invention relates generally to the field of Unmanned Aerial Vehicle (UAV) photography, and in particular to a UAV aerial photographing system.

### BACKGROUND OF THE INVENTION

Aerial photography, also called as air photography, refers to photographing activities performed in the air with regard to the Earth's landforms, urban landscape, persons and other aspects. At present, UAV aerial photography has been widely used in military applications, traffic construction, water conservancy projects, ecological research, television programs and art photography and so on. However, the UAV aerial photography in the prior art can only perform flight and photographing in a single mode and cannot meet demands in plural aspects, causing an inconvenience for users.

### SUMMARY OF THE INVENTION

A technical problem to be solved by the present invention is to provide a UAV aerial photographing system capable of implementing multi-mode aerial photographing, thereby overcoming a drawback of the UAV aerial photography in the prior art which can only perform flight and photographing in a single mode and cannot meet demands in plural aspects.

The present invention solves the aforementioned technical problem by use of the following technical solution:

A UAV aerial photographing system, comprising a remote control device, a UAV, and a PTZ camera,

wherein the remote control device is used to transmit a flight instruction to the UAV;

wherein the UAV is used to fly in any one of the following modes according to the flight instruction:

mode 1: flying around a target point with a preset distance from the target;

mode 2: flying a first preset distance on a straight line formed by a target point and a lens angle of the PTZ camera in a direction away from the target point;

mode 3: flying according to a curved preset path;

mode 4: flying with a preset angle and a preset distance kept between the UAV and the remote control device; and

wherein the PTZ camera is used to perform photographing during flight of the UAV.

In this solution, the remote control device is used to transmit a flight instruction to the UAV, the UAV is used to fly in different modes according to different flight instructions, and the PTZ camera is used to perform photographing during flight of the UAV. In this way, UAV aerial photographing in multiple flight modes is implemented, which provides a plurality of options for users, and meanwhile, pictures with diverse effects can also be taken, which satisfy users' demands in plural aspects.

Mode 1 is flying around a first target point, wherein both the first target point and a preset radius for the surrounding flight are decided by a flight instruction. Specifically, in use, a user can transmit via a remote control device to the UAV, a flight instruction including the location of the first target point and a preset flight radius. By doing so, the user can determine a specific region for the surrounding flight by means of the remote control device.

Mode 2, which is flying a preset distance on a straight line formed by a location of the target point and a lens angle of the PTZ camera in a direction away from the target point, includes designating a substantially straight flight path between the target point and the lens angle of the PTZ camera, on which the UAV flies in the direction away from the location of the target point, wherein a value of the preset distance depends on a flight instruction transmitted by the remote control device. This flight mode can enable the UAV to take pictures from special perspectives, giving the users a brand new feeling.

Mode 3, which is flying according to a curved preset path, means that the UAV will fly according to a preset path based on a flight instruction transmitted by the remote control device, wherein the preset path is non-linear.

Mode 4, which is flying with a preset angle and a preset distance kept between the UAV and the remote control device, means that a fixed angle and a fixed distance are substantially maintained between the UAV during flight and the remote control device. This means that when the remote control device moves, the UAV will also move along with the remote control device, so that the fixed angle and the fixed distance can be always kept therebetween, wherein the preset angle and the second preset distance between the UAV and the remote control device are decided by a flight instruction transmitted by the remote control device.

Preferably, when the UAV flies in mode 1, the PTZ camera is used to take photograph of the target point and/or the surrounding area. In this embodiment, a subject of the PTZ camera is the target point, and specifically, the PTZ camera performs 360° surrounding photographing of the target point.

Preferably, the target point in mode 1 includes persons and scenes. In this solution, the target point is not limited to a person or a scene, but may also be another object such as a building.

In accordance with an embodiment of the invention, when the UAV flies in mode 1, the PTZ camera can be used to take photograph of a region including a substantially circular area formed with the target point as a center and the preset radius as a radius.

In this embodiment, the subject of the PTZ camera is not the first target point, and specifically, the PTZ camera takes photograph of a region including a range formed with the first target point as a center and the preset radius as a radius.

In accordance with one embodiment, the target point is the remote control device. In this embodiment, the PTZ camera is used to take photograph of a region including a range formed with the remote control device as a center and the preset distance as a radius.

Preferably, when the UAV flies in mode 1, the remote control device is further used to adjust a radial distance and height for the surrounding flight of the UAV during flight of the UAV. In this solution, during the flight of the UAV in mode 1, the radial distance and height for the surrounding flight can be adjusted by means of the remote control device.

Preferably, when the UAV flies in mode 2, the UAV is further used to, when the first preset distance reaches a preset threshold, return a location from where the UAV received the flight instruction.

In this embodiment, the preset threshold is decided by the flight instruction transmitted from the remote control device.

Preferably, the preset threshold is in a range of 20-100 meters.

In accordance with one embodiment, during operation of mode 2 the target point can be a person, a scene or the remote control device.

Preferably, the remote control device is further used to control a photographing angle of the PTZ camera during flight of the UAV.

Preferably, the UAV is further used to stop flying upon detection of a front obstacle during flight, or to avoid the front obstacle and continue to fly in a current mode. In this solution, the UAV has a function of avoiding an obstacle, which prevents the UAV against damage.

On the basis of the conformance to common knowledge in the art, the preferred conditions described above can be combined, thereby arriving at preferred embodiments of the present invention.

The present invention has the following positive progress and effect: compared with the prior art, the present invention transmits different flight instructions to the UAV by means of the remote control device, and can enable the UAV to fly in different modes, and meanwhile, the PTZ camera performs photographing during flight of the UAV. In this way, UAV aerial photographing in multiple flight modes is implemented, which provides a plurality of options for users, and meanwhile, pictures with diverse effects can also be taken, which satisfy users' demands in plural aspects.

### BRIEF DESCRIPTION OF THE ACCOMPANYING DRAWINGS

FIG. 1 is a block diagram of a UAV aerial photographing system according to an embodiment of the present invention.

### DETAILED DESCRIPTION OF PREFERRED EMBODIMENTS

A further description of the present invention is made below by way of an embodiment, but the present invention is not restricted within the scope of the embodiment for this reason.

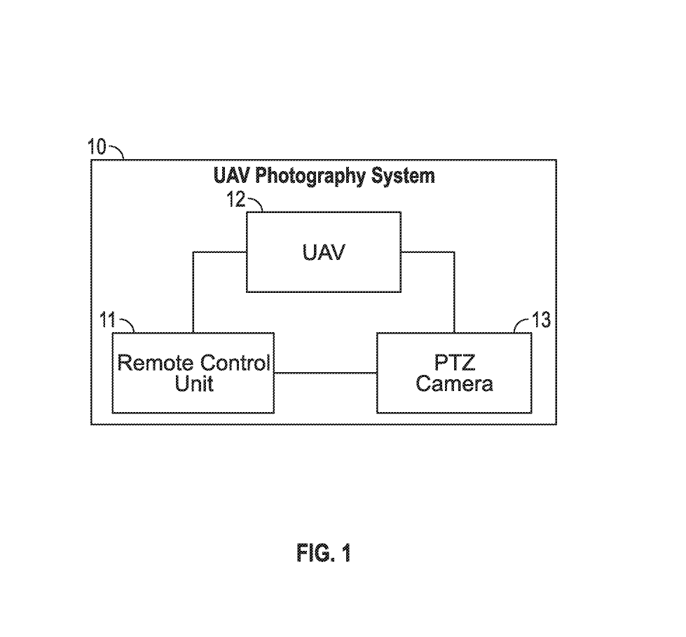

This embodiment provides a UAV aerial photographing system 10, which, as shown in FIG. 1, comprises a remote control device 11, a UAV 12 and a PTZ camera 13.

The remote control device 11 is used to transmit a flight instruction to the UAV 12.

The UAV 12 can be used to fly in mode 1 according to the flight instruction, i.e., fly surrounding a target point with a preset radius, wherein during flight of the UAV 12, the remote control device 11 is further used to adjust a distance and a height for the surrounding flight of the UAV 12.

When the first target point is a person or a scene, the PTZ camera 13 is used to take photograph of the first target point during the flight of the UAV 12, wherein the preset radius may be 5 meters or 10 meters. During mode 1 operation, when the target point is the remote control device, the PTZ camera 13 is used to take photograph of a region including a range formed with the remote control device as a center and the preset radius as a radius, wherein the preset radius may be 5 meters or 10 meters, as examples.

Further, the UAV 12 can further be used to fly in mode 2 according to the flight instruction, i.e., fly a first preset distance on a straight line formed by a target point and a lens angle of the PTZ camera in a direction away from the target point, wherein when the first preset distance reaches a preset threshold, the UAV 12 is further used to return a location where it was before receiving the flight instruction. In this embodiment, the preset threshold can be 30 meters or 50 meters; wherein the target point may be a person, or a scene, or the remote control device.

Further, the UAV 12 can be further used to fly in mode 3 according to the flight instruction, i.e., fly according to a curved preset path, and the PTZ camera 13 is used to perform photographing during the flight of the UAV.

Further, the UAV 12 can be further used to fly in mode 4 according to the flight instruction, i.e., fly with a preset angle and a preset distance kept between the UAV and the remote control device, and the PTZ camera 13 is used to perform photographing during the flight of the UAV. Taking an example, if the remote control device moves forward a distance L1 in a horizontal direction, then the UAV will also move forward the distance L1 in the horizontal direction; if the remote control device moves upward a distance L2 in a vertical direction, then the UAV will also move upward the distance L2 in the vertical direction; if the remote control device moves upward a distance L4 in the vertical direction while moving upward a distance L3 in the horizontal direction, then the UAV will also move upward the distance L4 in the vertical direction while moving upward the distance L3 in the horizontal direction.

Moreover, in this embodiment, during the flight of the UAV, the remote control device can also be used to control a photographing angle of the PTZ camera. For preventing the UAV against damage, the UAV is also used to stop flying upon detection of a front obstacle during flight, or to avoid the front obstacle and continue to fly in a current mode.

This embodiment transmits different flight instructions to the UAV by means of the remote control device, and can enable the UAV to fly in different modes, and meanwhile, the PTZ camera performs photographing during flight of the UAV, so that UAV aerial photographing in multiple flight modes is implemented, which provides a plurality of options for users, and meanwhile, pictures with diverse effects can also be taken, which satisfy users' demands in plural aspects.

In accordance with one embodiment of the present invention, modes 1-4 of operation can be preprogrammed into the remote control unit, and the remote control unit may include a plurality of dedicated buttons, each of which corresponds to a respective mode of operation. Upon the user manipulation of one of the buttons, the remote control unit automatically instructs the UAV to enter into the corresponding mode of operation.

While embodiments of the present invention have been described above, it is to be understood by those skilled in the art that these are only exemplary explanations. The scope of protection of the present invention is defined by the appended claims. Without departing from the principle and essence of the present invention, those skilled in the art can make various changes or modifications to these embodiments, but these changes and modifications all fall within the scope of protection of the present invention.

What is claimed is:

1. A UAV aerial photographing system, comprising:
a remote control device;
a UAV; and
a PTZ camera mounted on the UAV,
wherein the remote control device is capable of transmitting a flight instruction to the UAV, said flight instruction including instruction for commanding the UAV to flight in any one of the following modes according to the flight instruction:
mode 1: flying around a target location with a constant radial distance between the UAV and said target location;
mode 2: flying a first preset distance on a straight line formed by a target location and a lens angle of the PTZ camera in a direction away from the target location;
mode 3: flying according to a curved path preset by the user on the remote control device;
mode 4: maintaining a user-specified angle and distance in relation to the location of the remote control device, and
wherein the PTZ camera is used to perform photographing during flight of the UAV.

2. The UAV aerial photographing system according to claim 1, wherein when the UAV flies in mode 1, the PTZ camera is used to take photograph of the target location.

3. The UAV aerial photographing system according to claim 2, wherein the target is one of a person and a scene.

4. The UAV aerial photographing system according to claim 1, wherein when the UAV flies in mode 1, the PTZ camera is used to take photograph of a region including a range formed with the target location as a center and the preset distance as a radius.

5. The UAV aerial photographing system according to claim 4, wherein the target point is the remote control device.

6. The UAV aerial photographing system according to claim 1, wherein when the UAV flies in mode 1, the remote control device is further used to adjust a radial distance and altitude for the surrounding flight of the UAV during flight of the UAV.

7. The UAV aerial photographing system according to claim 1, wherein when the UAV flies in mode 2, the UAV is further used to return a location where it was before receiving the flight instruction when the first preset distance reaches a preset threshold.

8. The UAV aerial photographing system according to claim 7, wherein the preset threshold is in a range of 20-100 meters.

9. The UAV aerial photographing system according to claim 7, wherein the target is one of a person, a scene and the remote control device.

10. The UAV aerial photographing system according to claim 1, wherein the remote control device is capable of controlling an orientation of PTZ camera during flight of the UAV.

11. The UAV aerial photographing system according to any one of claim 1, wherein the UAV is further capable of stop flying upon detection of a front obstacle during flight, or to avoid the front obstacle and continue to fly in a current mode.

12. The UAV aerial photography system according to claim 1, wherein the remote control device includes a plurality of dedicated buttons, each of which correspond to one of mode 1-4 operations.
